(19) United States
(12) Patent Application Publication
(10) Pub. No.: US 2011/0170281 A1
(43) Pub. Date: Jul. 14, 2011

(54) Pick up tool with illuminating and magnet attracting functions

(76) Inventor: Leo Shih, Taichung (TW)

(21) Appl. No.: 12/684,926

(22) Filed: Jan. 9, 2010

(51) Int. Cl. B25B 23/18; B66C 1/42

(52) U.S. Cl. 362/119; 294/99.1

(57) ABSTRACT

A pick up tool with illuminating and magnet attracting functions comprises a cylindrical member including cells provided therein, a control member disposed at the rear end of the cylindrical member and including a bolt for fitting a spring thereon, as the bolt is pressed to move, it may contact with the electrode output end of the cells, a sleeve mounted at the front end of the cylindrical member for confining the cells and including a spring fitted thereon and a string fixed at the front end thereof, the string including an expandable claw attached at the front end thereof, a tube secured at the front end of the sleeve for inserting the string and positioning the claw, a bulb affixed on the tube and including anode and cathode output wires, the anode output wire fixed on the tube, while the cathode output wire passing through the sleeve and contacting with the cathode output end of the cells, thereby simultaneously obtaining the picking and illumining purpose.

### BACKGROUND OF THE INVENTION

1. Field of the Invention

The present invention relates to a pick up tool with illuminating and magnet attracting functions that when the control member is pressed to turn on the bulb, the expandable claw is used to pick up the object or the magnetic loop of the second post is selected to attract the object, thus obtaining easy operation, illuminating and magnetically attracting functions.

2. Description of the Prior Arts

As shown in FIGS. 1 and 2, a conventional pick up tool includes a first post 1, the first post 1 includes a disc 101 radially extending from an outer rim of a rear end thereof, and includes a flexible extending stem 11 connected to a front end thereof, the extending stem 11 includes a second post 12 coupled to a front end thereof, and the first post 10 also includes a shaft 14 with a resilient element 13 fitted on the rear end thereof, the shaft 14 includes a flexible string 15 fixed on a front end thereof to inert through the first post 10, the extending stem 11, and the string 15 includes an expandable claw 17 connected to a front end thereof by using a limiting member 16 so that the expandable claw 17 is located at a front end of the second post 12. When the pick up tool is not used, the shaft 14 is pushed by the resilient element 13 to actuate the string 15 and the claw 17 to move rearward so that the claw 17 is guided and pressed by the second post 12 to retract in the front end of the second post 12. As illustrated in FIG. 3, when user pucks up an object in a narrow space by using the pick up tool, the extending stem 11 and the string 15 are flexible so that the second post 12 is placed to the narrow space, and the claw 17 is inserted to a position where the object is located, and the disc 101 of the first post 10 is held by one hand, then a pressing panel 141 of the shaft 14 is operated to compress the resilient element 13, such that the shaft 14 actuates the string 15 to move forward to push the claw 17 to extend out of the second post 12, expanding the claw 17 to pick up the object. With reference to FIG. 4, when the claw 17 claws the object, the pressing panel 141 is released so that the shaft 14 is pushed by the resilient element 13 to actuate the string 15 to move rearward, and the claw 17 is pulled by the string 15 to move rearward and then guided by the second post 12 to be retracted inward, thus picking up the object. However, such a conventional pick up tool is used in the narrow but dim space, therefore the user can not see the object clearly. If he still intends to pick the object in the dim space, a flashlight has to be held by another hand to illuminate the object, having an inconvenient operation. To solve above-mentioned defect, an illuminable picker disclosed in U.S. Pat. No. 7,527,311 is developed. Referring to FIGS. 5-7, the illuminable picker comprises a first post 20 including a disc 201 extending radially from an outer rim of a rear end thereof, and including a flexible extending stem 21 connected to a front end thereof, the extending stem 21 includes a second post 22 coupled to a front end thereof to receive a bulb 28, and the first post 20 also includes a shaft 24 with a resilient element 23 fitted to a rear end thereof, and the shaft 24 includes a flexible string 25 coupled to a front end thereof to insert through the first post 20, the extending stem 21, and the second post 22, and a front end of the string 25 of the second post 22 is connected to the expandable claw 27 by using a limiting member 26 so that the claw 27 is located at a front end of the second post 12. The shaft 24 also includes a holder 241 disposed on a rear end thereof to receive a cell set 29, and a first electrode of the cell set 29 is connected to a first connecting leg 281 of a bulb 28 by ways of a conductive wire 30, the holder 241 includes a receiving cylinder 31 screwed on a rear end thereof, and the receiving cylinder 31 includes a control member 34 with a resilient element 32 and a conducting bolt 33 received therein to press and release the control member 34 so that a second electrode of the cell set 29 is conducted to a second connecting leg 282 of the bulb 28. As shown in FIG. 8, when user presses the control member 34, the resilient element 32 is pressed by the control member 34 to actuate the conducting bolt 33 to move forward so that the conducting bolt 33 contacts with the second electrode of the cell set 29, and due to the first electrode of the cell set 29 has connected with the first connecting leg 281 of the bulb 28, the second electrode of the cell set 29 is conducted to the second connecting leg 282 via the conducting bolt 33, the control member 34, the receiving cylinder 31, the holder 241, the shaft 24, the first post 20, the extending stem 21, and the second post 22, thereby conducting a circuit to turn on the bulb 28 so that the user can see the object clearly. Referring to FIG. 9, when the bulb 28 is turned on, the user can press the control member 34 continuously so that the control member 34 actuates the shaft 24 to compress the resilient element 23 to move forward, and the string 25 and the claw 27 are actuated to move forward so that the claw 27 extends out of the second post 22, and the claw 27 expands outward without being pressed by the second post 22 to illuminate and pick up the object, however, the illuminable picker still has the following disadvantages:

1. The illuminable picker allows to pick up the object by using the claw 27, and the control member 34 is pressed to expand the claw 27 and turn on the bulb 28, therefore in a bright space, the electricity from the bulb 28 is wasted.

2. The claw 27 is used to pick up the object, accordingly the control member 34 has to be pressed every time to push the shaft 24 to compress the resilient element 23 so that the claw 27 is pushed to expand, but such a picking method can not pick up a tiny article securely.

The present invention has arisen to mitigate and/or obviate the afore-described disadvantages.

### SUMMARY OF THE INVENTION

The primary object of the present invention is to provide a pick up tool with illuminating and magnet attracting functions that is operated easily.

Further object of the present invention is to provide a pick up tool with illuminating and magnet attracting functions that is capable of picking up a tiny article securely.

Another object of the present invention is to provide a pick up tool with illuminating and magnet attracting functions that allows to picking up the tiny article without turning the bulb to save electricity.

In accordance with the present invention, there is provided a pick up tool with illuminating and magnet attracting functions comprising:

a first post;

an extending stem connected to a front end of the first post;

a second post coupled to a front end of the extending stem, and including a magnetic loop fixed on an outer periphery of a front end thereof, and including an expandable claw received in the front end thereof;

a bulb received in the second post thereof and including a first connecting leg and a second connecting leg;

a shaft fitted in a rear end of the first post by using a resilient element and including a flexible string inserted through the first post, the extending stem, and the second post, and a front end of the flexible string connecting with the expandable claw of the second post, and the shaft including a holder mounted on a rear end thereof, the holder including a conductive wire coupled to the first connecting leg of the bulb;

a receiving cylinder fixed on a rear end of the holder of the shaft;

a cell set defined between the holder of the shaft and the receiving cylinder, and a first electrode of the cell set contacting with the conductive wire of the holder;

a control member disposed on a rear end of the receiving cylinder, and coupled with a conducting bolt to be pushed to contact with a second electrode of the cell set, the conducting bolt allowing to conduct the second electrode of the cell set with the second connecting leg of the bulb.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective view showing the exploded components of a conventional pick up tool;

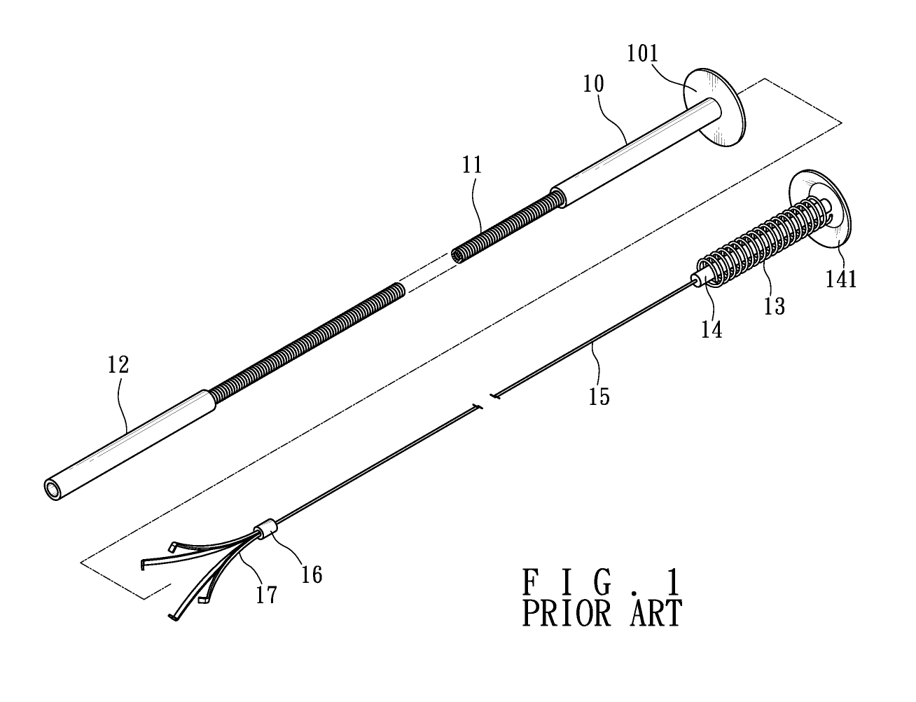

FIG. 2 is a perspective view showing the assembly of the conventional pick up tool;

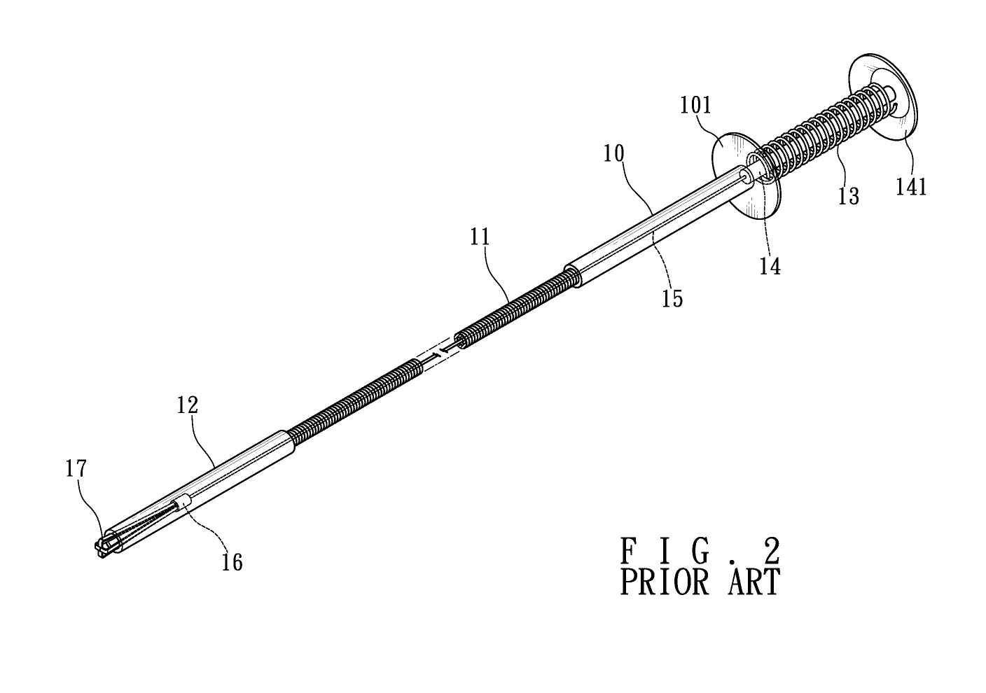

FIG. 3 is a cross sectional view showing the operation of the conventional pick up tool;

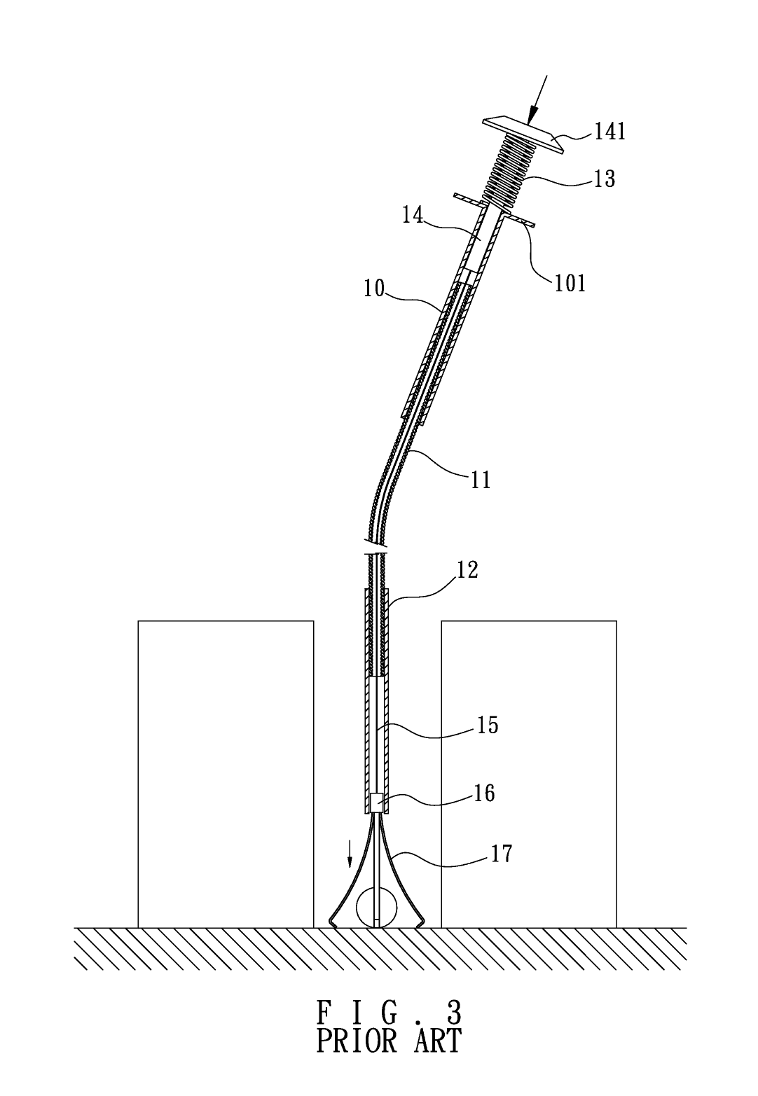

FIG. 4 is another cross sectional view showing the operation of the conventional pick up tool;

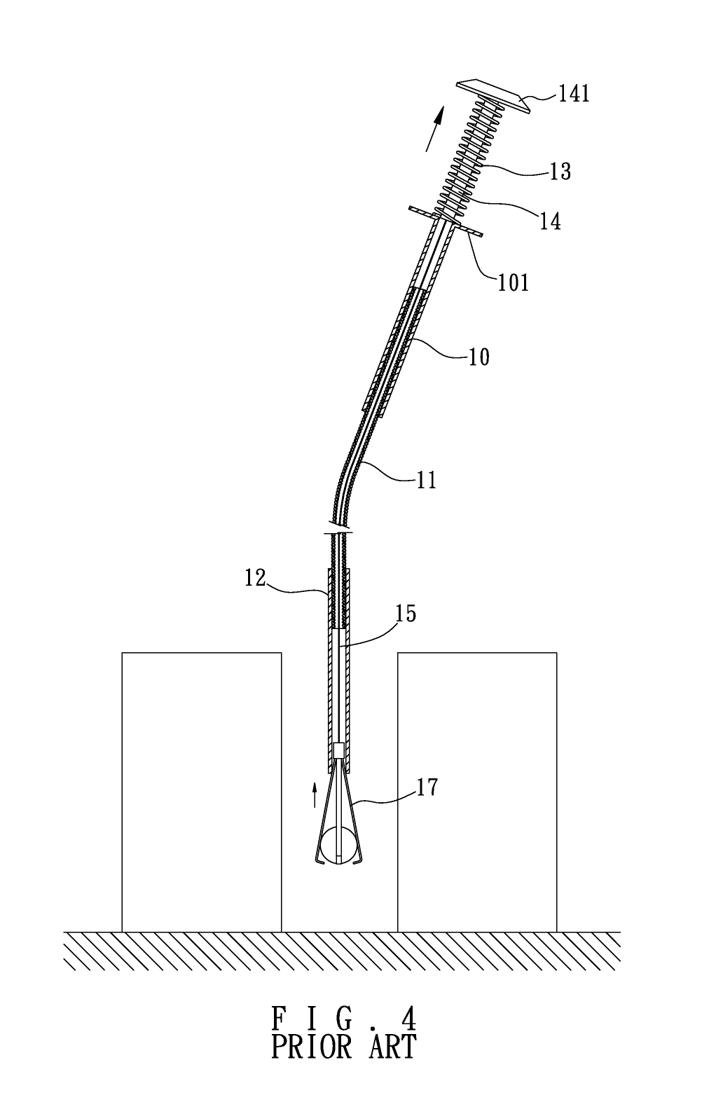

FIG. 5 is a perspective view showing the exploded components of a conventional illuminable picker of U.S. Pat. No. 7,527,311;

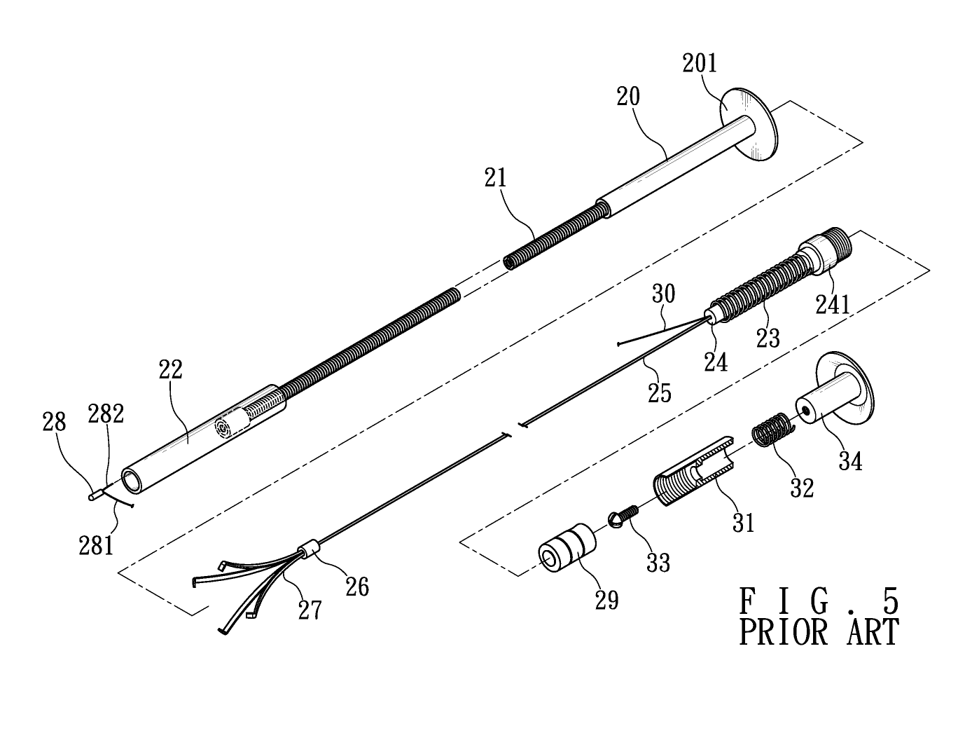

FIG. 6 is a perspective view showing the assembly of the conventional illuminable picker of U.S. Pat. No. 7,527,311;

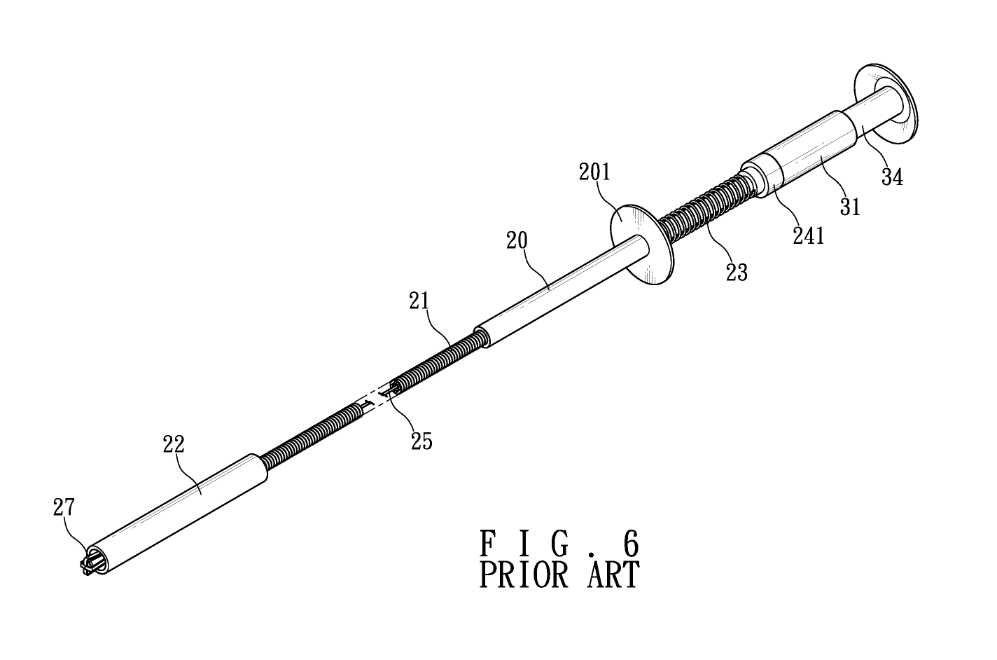

FIG. 7 is a cross sectional view illustrating the assembly of the conventional illuminable picker of U.S. Pat. No. 7,527,311;

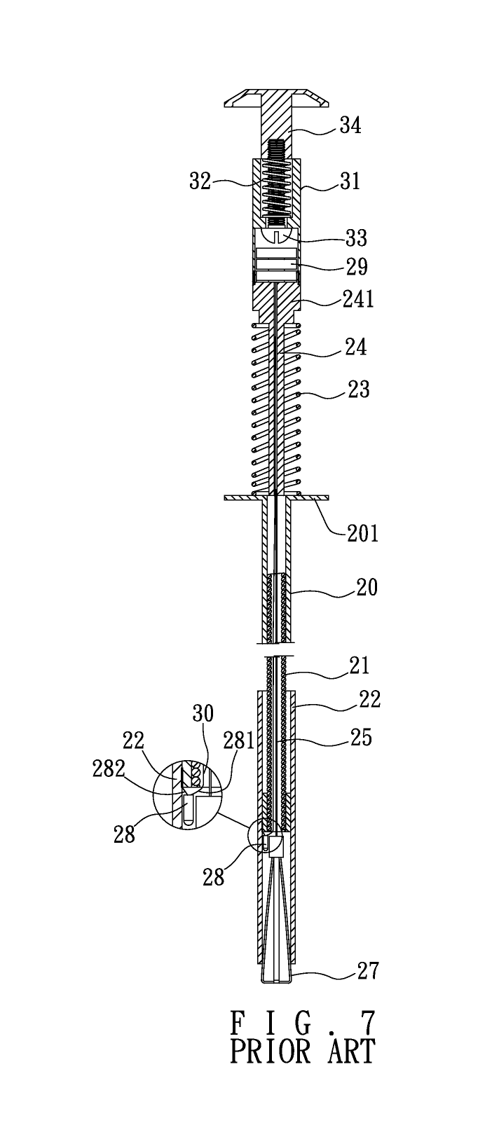

FIG. 8 is a cross sectional view showing the operation of the conventional illuminable picker of U.S. Pat. No. 7,527,311;

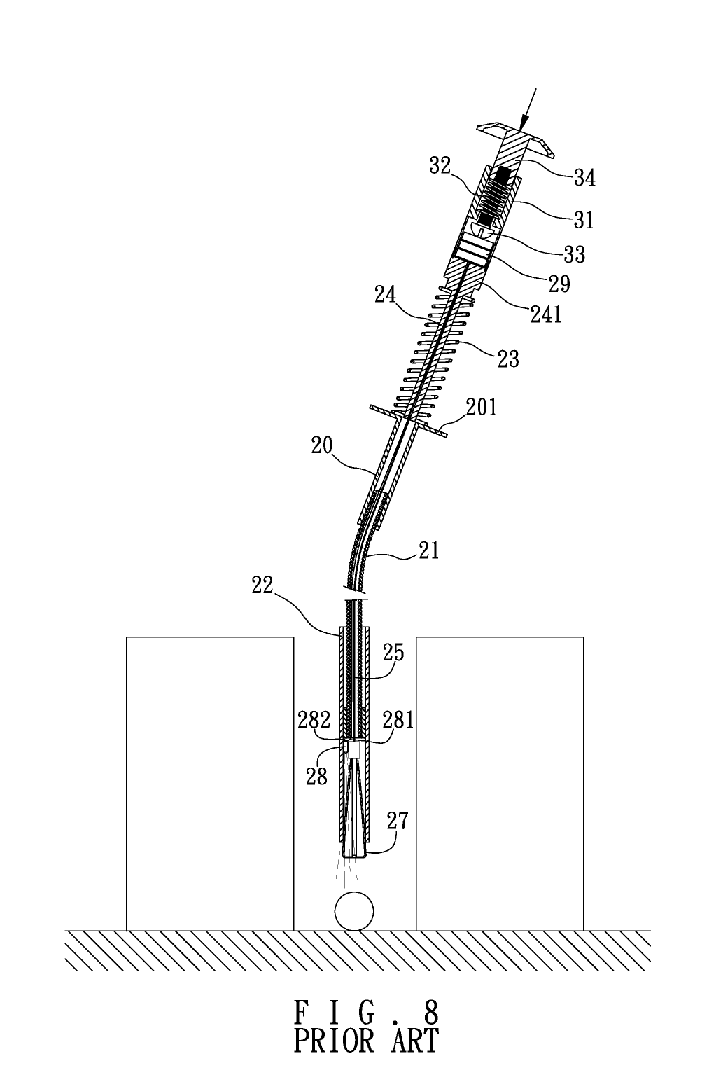

FIG. 9 is another cross sectional view showing the operation of the conventional illuminable picker of U.S. Pat. No. 7,527,311;

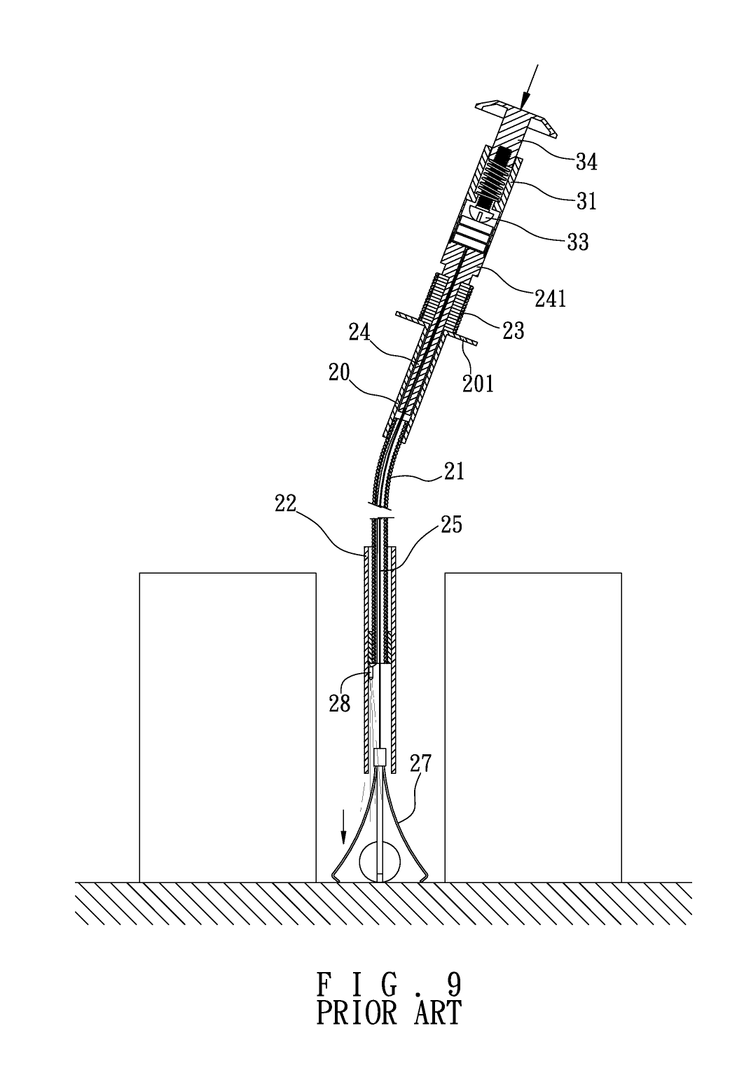

FIG. 10 is a perspective view showing the exploded components of a pick up tool with illuminating and magnet attracting functions according to a preferred embodiment of the present invention;

FIG. 11 is a perspective view showing the assembly of the pick up tool with illuminating and magnet attracting functions according to the preferred embodiment of the present invention;

FIG. 12 is a cross sectional view showing the assembly of the pick up tool with illuminating and magnet attracting functions according to the preferred embodiment of the present invention;

FIG. 13 is a cross sectional view showing a bulb being turned on to illuminate an object as desiring to pick up it;

FIG. 14 is a cross sectional view showing an expandable claw being expanded to pick up the object;

FIG. 15 is a cross sectional view showing a magnetic loop being used to attract a tiny article;

FIG. 16 is another cross sectional view showing the magnetic loop being used to attract the tiny article.

### DETAILED DESCRIPTION OF THE PREFERRED EMBODIMENT

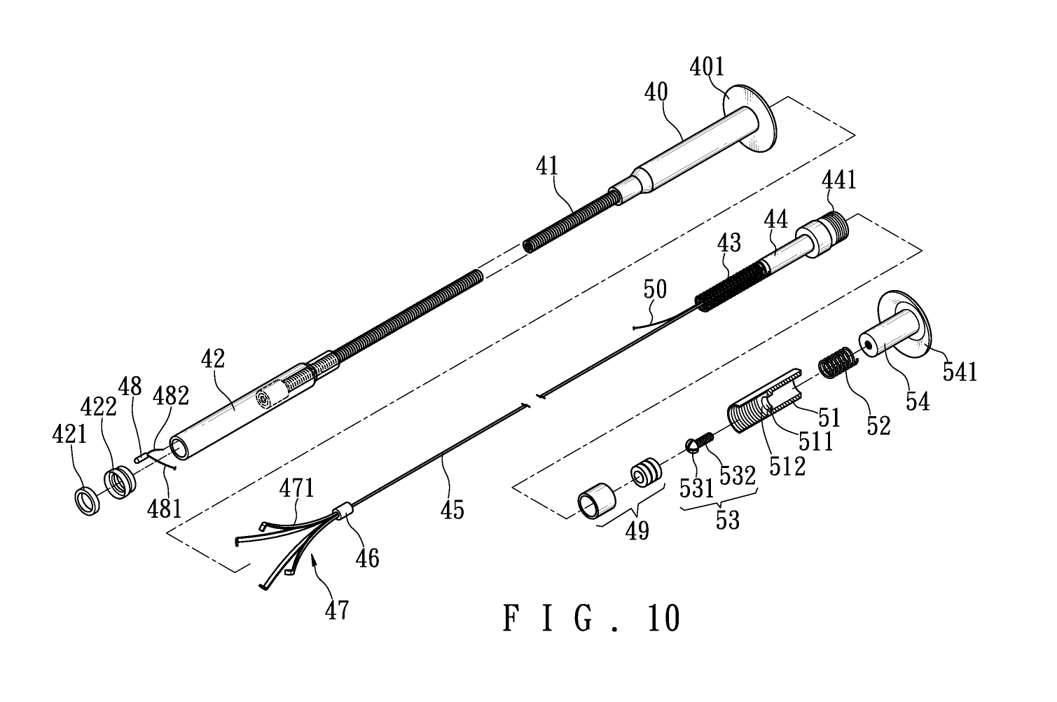

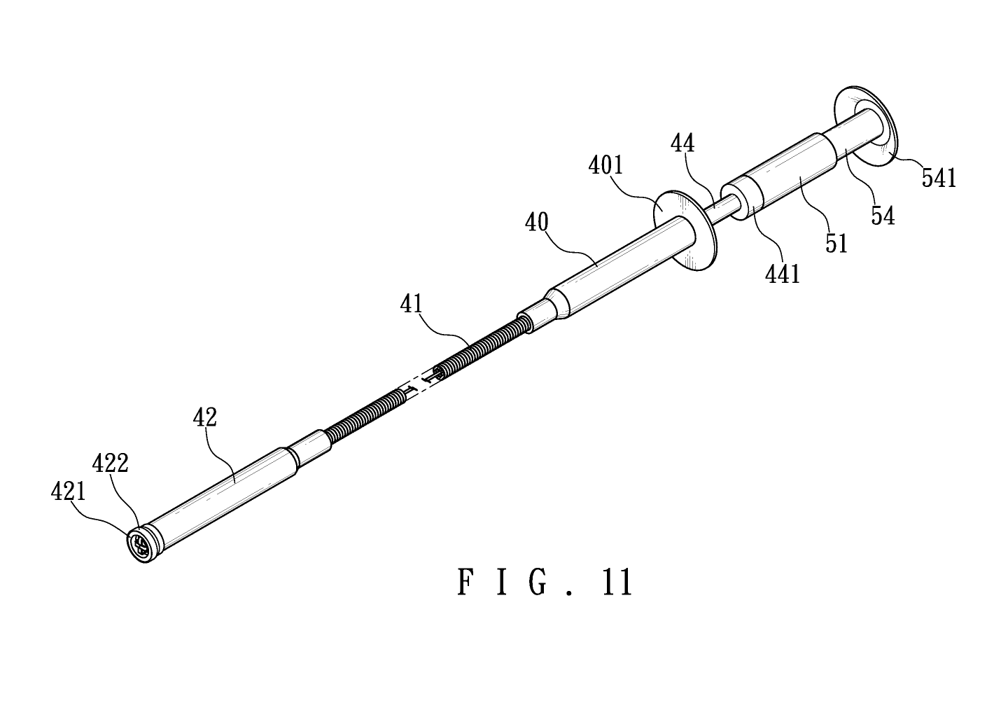

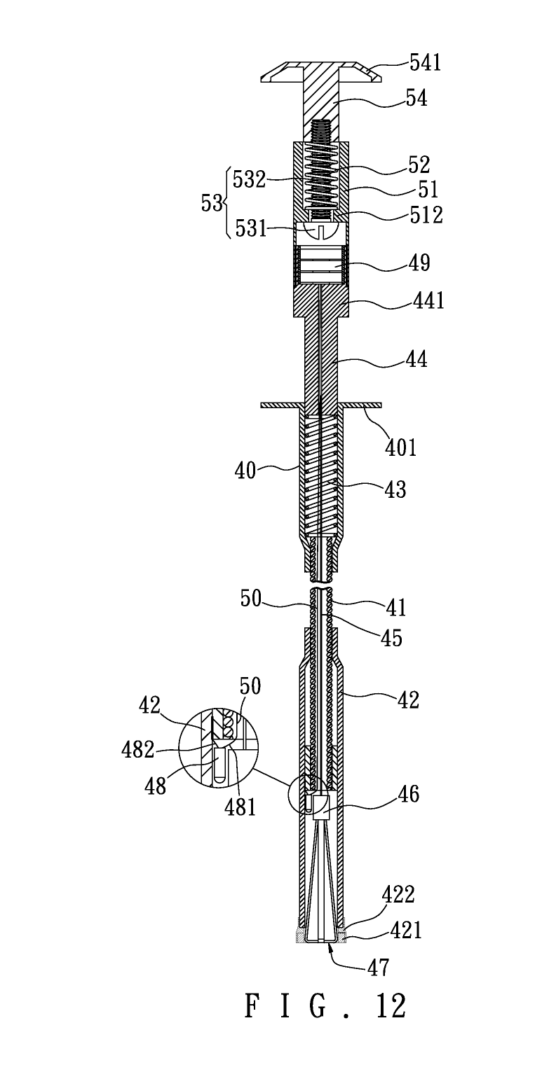

Referring to FIGS. 10-12, a pick up tool with illuminating and magnet attracting functions in accordance with the present invention comprises a first post 40 including a disc 401 radially extending from an outer rim of a rear end thereof, including a flexible extending stem 41 connected to a front end thereof, the extending stem 41 including a second post 42 coupled to a front end thereof, and the second post 42 including a magnetic loop 421 fixed on an outer periphery of a front end thereof by using an insulating sleeve 422, and including a bulb 48 received therein, the bulb 48 including a second connecting leg 482 to contact with an inner wall of the second post 42, and the first post 40 including a resilient element 43 and a shaft 44 fitted to the rear end thereof. In this embodiment, the resilient element 43 is a spring to abut against a front end of the shaft 44 so that the shaft 44 allows to compress the spring to move in the first post 40, the shaft 44 includes a flexible string 45 to insert through the first post 40, the extending stem 41, and the second post 42. In this embodiment, the flexible string 45 is made of steel material, and a front end of the flexible string 45 is connected with an expandable claw 47 by using a limiting member 46 so that the expandable claw 47 is located at a front end of the second post 42. In this embodiment, the expandable claw 47 is provided with four L-shaped steel pieces 471 to expand flexibly, and the shaft 44 includes a holder 441 disposed on a rear end thereof, the holder 441 includes a conductive wire 50 coupled to a first connecting leg 481 of the bulb 48, and includes a receiving cylinder 51 screwed to a rear end thereof, and the receiving cylinder 51 includes a stop plate 512 with a through hole 511 mounted at a suitable position thereof, between a front end of the stop plate 512 and the holder 441 is defined a cell set 49, one first electrode of which contacts with the conductive wire 50 to conduct the first connecting leg 481 of the bulb 48, and the stop plate 512 includes an elastic member 52 and a control member 54 with a pressing panel 541 received therein, and a conducting bolt 53 includes a large-diameter abutting portion and 531 and a small-diameter screwing portion 532, and the abutting portion 531 of the conducting bolt 53 is located at the front end of the stop plate 512, and the screwing portion 532 inserts through the through hole 511 and the elastic member 52 to screw with the control member 54, such that when the control member 54 is pressed, the abutting portion 531 of the conducting bolt 53 is pushed to contact with a second electrode of the cell set 49 so as to conduct the second connecting leg 482 of the bulb 48.

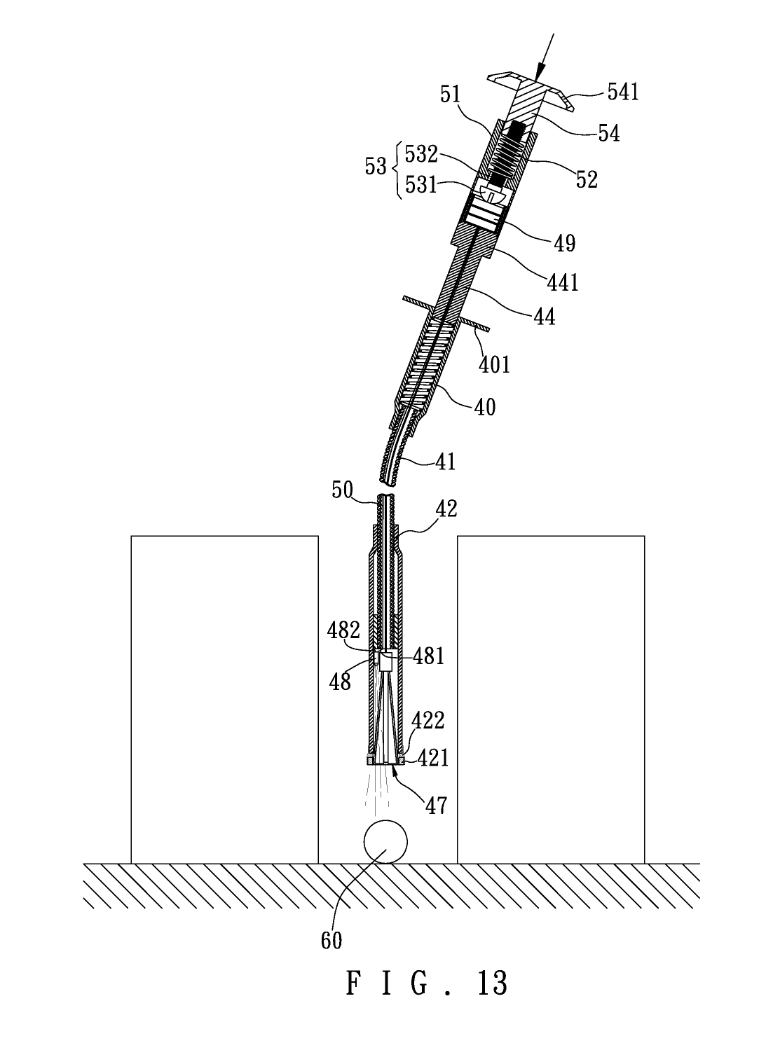

Referring to FIG. 13, when user presses the control member 54, the elastic member 52 is compressed by the control member 54 to push the conducting bolt 53 to move forward so that the abutting portion 531 of the conducting bolt 53 contacts with the second electrode of the cell set 49, and because the first electrode of the cell set 49 has connected with the first connecting leg 481 of the bulb 48 via the conductive wire 50, the second electrode of the cell set 49 can conduct the second connecting leg 482 of the bulb 48 through the conducting bolt 53, the control member 54, the receiving cylinder 51, the holder 441, the shaft 44, the first post 40, the extending stem 41, and the second post 42, such that a circuit is conducted to turn on the bulb 48, thus picking up an object 60 clearly.

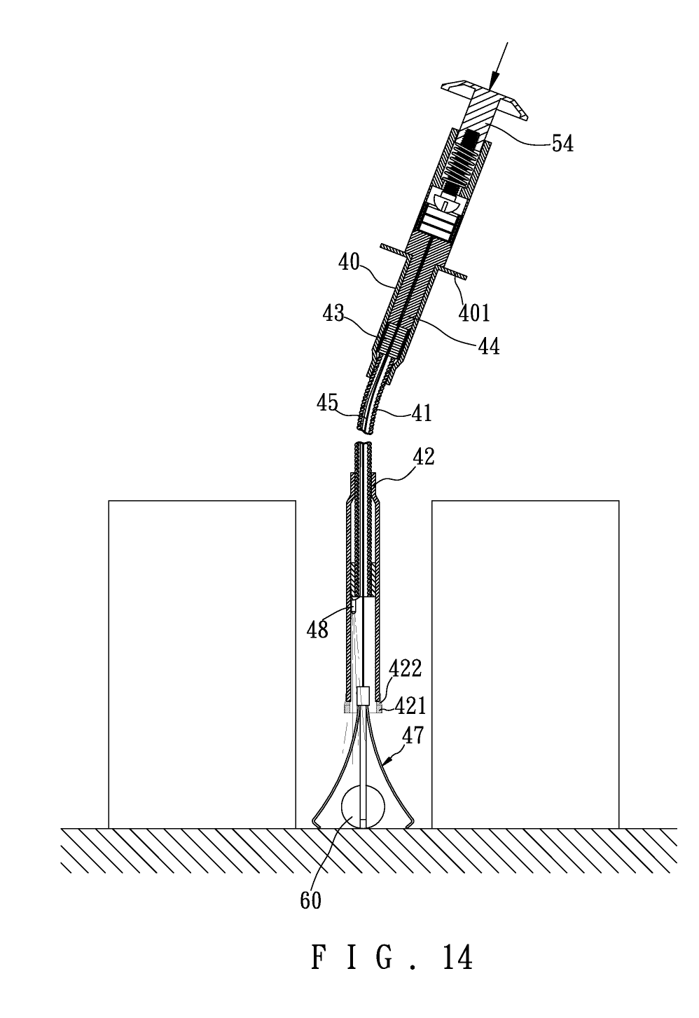

As shown in FIG. 14, as the bulb 48 is turned on, the user further presses the control member 54 to actuate the shaft 44 to compress the resilient element 43, and then the resilient element 43 moves forward to actuate the flexible string 45 and the expandable claw 47 to move forward, hence the expandable claw 47 extends out of the second post 42 to expand outward to pick up the object 60.

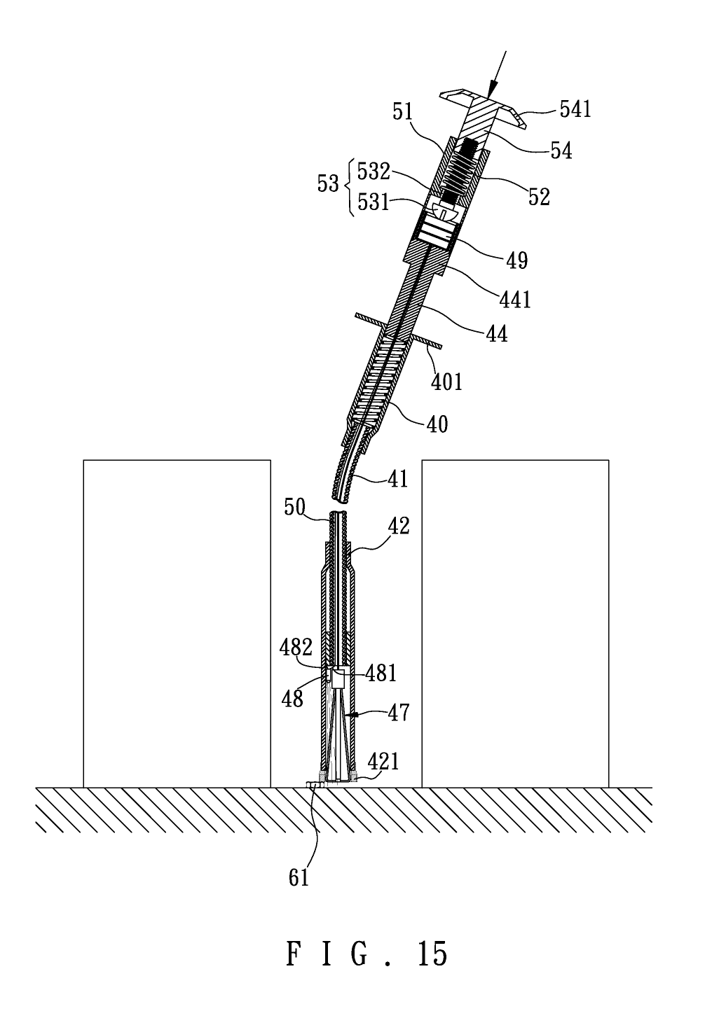

As shown in FIG. 15, as picking up a tiny article 61 in a dim space, the control member 54 is pressed so that the abutting portion 531 of the conducting bolt 53 contacts the second electrode of the cell set 49 to turn on the bulb 48, therefore user can see the tiny object 61 exactly, and then he can apply a front end surface of the second post 42 to attract the tiny article 61 without pressing the control member 54 continuously to expend the expandable claw 47, thereby picking up the tiny article 61 securely.

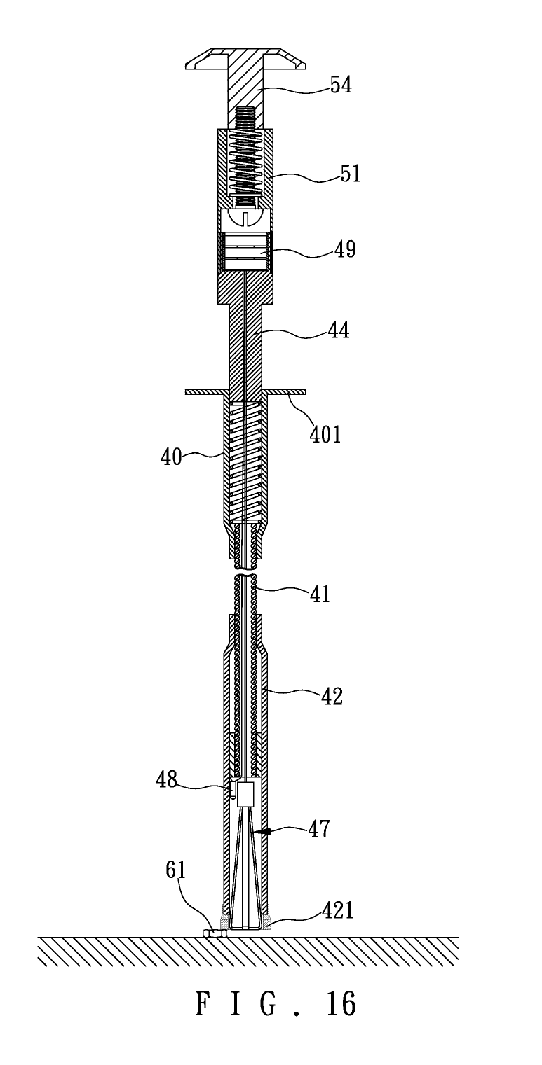

With reference to FIG. 16, as picking the tiny article 61 up in a narrow but bright space, the bulb 48 is not turned on and the user applies the front end surface of the magnetic loop 421 to attract the tiny article 61 without pressing the control member 54 continuously to expend the expandable claw 47, hence the electricity saving purpose is obtained.

The invention is not limited to the above embodiment but various modifications thereof may be made. It will be understood by those skilled in the art that various changes in form and detail may made without departing from the scope and spirit of the present invention.

What is claimed is:

1. A pick up tool with illuminating and magnet attracting functions comprising:
a first post;
an extending stem connected to a front end of the first post;
a second post coupled to a front end of the extending stem, and including a magnetic loop fixed on an outer periphery of a front end thereof, and including an expandable claw received in the front end thereof;
a bulb received in the second post thereof and including a first connecting leg and a second connecting leg;
a shaft fitted in a rear end of the first post by using a resilient element and including a flexible string inserted through the first post, the extending stem, and the second post, and a front end of the flexible string connecting with the expandable claw of the second post, and the shaft including a holder mounted on a rear end thereof, the holder including a conductive wire coupled to the first connecting leg of the bulb;
a receiving cylinder fixed on a rear end of the holder of the shaft;
a cell set defined between the holder of the shaft and the receiving cylinder, and a first electrode of the cell set contacting with the conductive wire of the holder;
a control member disposed on a rear end of the receiving cylinder, and coupled with a conducting bolt to be pushed to contact with a second electrode of the cell set, the conducting bolt allowing to conduct the second electrode of the cell set with the second connecting leg of the bulb.

2. The pick up tool with illuminating and magnet attracting functions in claim 1, wherein the first post includes a disc radially extending from an outer rim of a rear end thereof.

3. The pick up tool with illuminating and magnet attracting functions in claim 1, wherein the extending stem is flexible.

4. The pick up tool with illuminating and magnet attracting functions in claim 1, wherein the second post includes an insulating sleeve fixed on an outer periphery of the front end thereof, and the insulating sleeve includes a magnetic loop fixed on an inner wall thereof to attract an object.

5. The pick up tool with illuminating and magnet attracting functions in claim 1, wherein the flexible string is made of steel material.

6. The pick up tool with illuminating and magnet attracting functions in claim 1, wherein the string of the shaft is connected with the expandable claw by using a limiting member.

7. The pick up tool with illuminating and magnet attracting functions in claim 1, wherein the second leg of the bulb contacts contact with an inner wall of the second post, and when the conducting bolt of the control member is pushed to contact with the second electrode of the cell set, it is conducted to the second connecting leg of the bulb through the control member, the receiving cylinder, the shaft, the first post, the extending stem, and the second post.

8. The pick up tool with illuminating and magnet attracting functions in claim 1, wherein the receiving cylinder includes a stop plate with a through hole mounted, and the stop plate includes a control member received in a rear end thereof, the conducting bolt inserts through the through hole of the stop plate to screw with the control member so as to be pushed to contact with the second electrode of the cell set.

9. The pick up tool with illuminating and magnet attracting functions in claim 8, wherein the conducting bolt includes a large-diameter abutting portion and a small-diameter screwing portion, the abutting portion is located at a front end of the stop plate of the receiving cylinder, and the screwing portion inserts through the through hole of the stop plate to screw with the control member so as to push the abutting portion of the conducting bolt to contact with the second electrode of the cell set.

10. The pick up tool with illuminating and magnet attracting functions in claim 8, wherein the stop plate includes an elastic member mounted on the rear end thereof, and the conducting shaft inserts through the through hole and the elastic member to screw with the control member.
